(19) United States
(12) Patent Application Publication
(10) Pub. No.: US 2006/0235109 A1
(43) Pub. Date: Oct. 19, 2006

(54) Fingerprint ink composition

(76) Inventor: Ronald Stanley, Hawthorne, CA (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/240,263

(22) Filed: Sep. 30, 2005

Related U.S. Application Data
(63) Continuation-in-part of application No. 10/455,912, filed on Jun. 6, 2003, now abandoned.
(60) Provisional application No. 60/387,042, filed on Jun. 6, 2002.

(51) Int. Cl. C03C 17/00

(52) U.S. Cl. 523/160; 106/31.27; 524/300

(57) ABSTRACT

A dye-based fingerprint ink formulation includes a fatty-acid based dye dispersion including a fatty-acid based dye dispersed in a chemical composition having approximately equal first formulation parts of (a) 2 phenoxyethanol, (b) propylene glycol and (c) oleic acid and approximately equal second formulation parts of (d) sorbitan monopalmitate and (e) myristic acid, the second formulation parts being approximately one-half the amount of the first formulation parts, with the fatty-acid based dye being less than approximately one percent (1%), by weight, of the fatty-acid based dye dispersion.

### CROSS-REFERENCE TO RELATED PROVISIONAL AND UTILITY APPLICATIONS

This continuation-in-part application claims priority to the filing date of related provisional patent application Ser. No. 60/387,042 and a filing date of Jun. 6, 2002 and to utility patent application Ser. No. 10/455,912 with a filing date of Jun. 6, 2003.

### BACKGROUND OF THE INVENTION

1. Technical Field

The present invention is directed to fingerprinting ink compositions used for creation of fingerprints for identification purposes and, more particularly, to a non-staining, semi-inkless fingerprinting ink composition consisting of a dye mixture, non-volatile oil and a plurality of solvents to be used in a self contained fingerprinting pad.

2. Description of the Prior Art

Fingerprints have been used for many years to provide a method for the positive identification of individuals. For many years, fingerprints were obtained by dispensing a viscous ink onto a plate, the person to be fingerprinted rolling his or her fingers in the ink, then transferring the inked fingers to a piece of paper where the finger was rolled on the paper to transfer the fingerprint to the paper. Of course, this system had its inherent drawbacks, such as excessive staining of the skin and, due to the viscous nature of the ink, a somewhat slippery consistency which often resulted in smudged images of the fingerprint.

To improve the fingerprinting system of the prior art, and to permit the use of fingerprinting systems in retail and banking industries, for example, there have been developed numerous types of fingerprinting inks and fingerprinting systems which attempt to alleviate the disadvantages described previously. Critical features of such inks are that the fingerprinting ink must be non-staining on the skin so that customers are not required to clean up after using the fingerprinting ink and, further, that the ink must have a formulation which may be packaged for a period of time without separation of the ingredients thereof yet still function correctly. Also, it is desirable for the ink to possess sufficient opacity and neutrality of color for reproduction on microfilm and microfiche, as many documents are commonly disposed of after they have been recorded on film.

Fingerprinting inks which do not leave a visible residue on the fingertips have been available in the prior art for some time. However, such inks generally require the use of two separate chemical compounds, one being applied to the fingerprint area and the other transferred to the fingerprint-retaining surface after the fingerprinting procedure is performed to form a visible reaction product which shows the fingerprint. For obvious reasons, such a two-step process is both time-consuming and expands the potential for errors made during the fingerprinting process. There is therefore a need for a fingerprinting ink formulation which does not require the two-step process found in the prior art.

Also, in the prior art, there appear non-pigmented inks which slightly stain the fingertips but require a person to rub the fingers together to remove visible residue. For many years it has been known that solvents such as oleic acid, 2 phenoxyethanol and propylene glycol are excellent aids in the solubility of dyes. However, these solvents used by themselves would not provide a quality fingerprint necessary for identification purposes. They would tend to wick and bleed into the paper medium becoming blotchy. There is therefore a need for a fingerprinting ink that provides the necessary accuracy to determine an individual's identity, and which is also non-evident on the skin after touching the inked finger or thumb to the recording surface.

Ink foils are used for fingerprinting as well. However, they are not conducive for use in banks, retail outlets or notaries where a single digit is usually recorded. They are best suited for child fingerprinting kits or for criminal identification away from traditional booking facilities. Pulling apart the foil strips and handling them can be problematic for the user. It is easy to contaminate the fingers with the ink while trying to record the print to a specific block or area required on a form. Therefore, an object of the present invention is to provide an improved fingerprint ink composition.

Another object of the present invention is to provide an improved fingerprint ink composition which is non-staining and easily removable.

Another object of the present invention is to provide an improved fingerprint ink composition consisting of a dye, a non-volatile oil, a plurality of solvents and additional chemicals for increased viscosity and enhanced skin removability.

Another object of the present invention is to provide an improved fingerprint ink composition which can be used in a variety of applicator systems and may be quickly and easily substituted for inks of the prior art to provide improved fingerprinting capabilities.

Another object of the present invention is to provide an improved fingerprint ink composition which is usable in fingerprinting pads currently being manufactured.

Finally, an object of the present invention is to provide a fingerprint ink composition which is relatively simple and inexpensive to compose and is safe, efficient and easily removable in use.

### SUMMARY OF THE INVENTION

The present invention provides a fingerprint ink composition which requires only ½% to 1% of dye mixture dispersed in a chemical composition. The chemical composition includes (a) 2 phenoxyethanol, (b) propylene glycol, (c) oleic acid and (d) sorbitan monopalmitate and (e) myristic acid. Additives (d) and (e) assist in making the ink formulation non-staining to the skin and the two aid in binding the ink formulation together and enhances the viscosity necessary for optimal results.

It is thus seen that the present invention provides a substantial improvement over those inventions found in the prior art. For example, the fingerprint ink of the present invention permits the user to create accurate copies of the fingerprints and then quickly and easily remove the ink from his or her finger pad by merely wiping the finger pad with a cloth or paper towel or the like. Furthermore, as the present invention is relatively simple in composition and uses materials which are reasonably readily available, it is far more cost-effective to produce than those fingerprinting inks found in the prior art. Finally, because the fingerprint ink formulation of the present invention is usable with presently available ink pads, it may be easily substituted for currently available fingerprinting inks without requiring modification of the ink pads. The present invention thus provides a substantial improvement over the prior art.

### DESCRIPTION OF THE PREFERRED EMBODIMENT

The non-staining fingerprinting ink formulation of the present invention uses (½% to 1%) dye-based ink formulation which, in the preferred embodiment, would include equal parts of three solvent chemicals, specifically 2 phenoxyethanol, propylene glycol and a (fatty acid ester), such as oleic acid. With the use of these solvents and the base chemicals such as sorbitan monopalmitate and myristic acid in a ½ to ½ ratio with each of the solvent chemicals such that each of the three described solvents are equal in amount. These combined chemicals make the ink formulation of the present invention non-staining to the skin and bind the ink formulation together providing detailed fingerprint minutiae. These five combined chemicals provide the basis for the ink formulation of the present invention, with the remaining dye ingredient providing the coloration of the formulation to permit proper functioning of the ink on the reception and transference of fingerprints to a recording medium.

It should be noted that sorbitan monopalmitate and myristic acid combined in equal amounts complement each other and provide the preferred embodiment. However, one could replace the other completely in the formula and still function as a non-staining fingerprint ink. The preferred dye chemical used with the ink formation of the present invention is a free-flowing blackish-blue powder from the chemical family of azine hue, a family of fatty acid-based dye solutions. Specifically, the present invention contemplates the usage of Spectra Nigrosine, namely, Spectra Colors 8SL0007D, at a ratio of approximately 32.4 grams of dye to each gallon of the ink formulation being produced. The Spectra Nigrosine base dye is selected for use with the present invention as it offers good light fastness, strength, shade, and solubility for making the fingerprinting ink composition of the present invention.

Finally, approximately three point six grams (3.6 g) of 2 SL00031 Chrysoidine and one gram (1 g) of Violet 7SL00080 is added to the previously-described ink formulation components. In the preferred embodiment, the Chrysoidine acts to enhance the Spectra Nigrosine base dye and provide additional color depth to the ink formulation to increase the contrast of the ink formulation to the recording media such as paper which is used to receive the fingerprint. An important feature of the ink formulation of the present invention is that the dye amount is less than one and a half percent (1.5%) yet still provides acceptable contrast levels with high quality for identification purposes. This ink therefore solves two of the main problems encountered in the formulation of fingerprinting inks, first that the dye amount is low enough to ensure non-staining to the skin following completion of the fingerprinting process and second that the contrast level is maintained even with the lower dye percentage. The inventor is unaware of any other fingerprinting ink formulation in the prior art which solves both of these problems, and therefore believes himself to have invented a novel fingerprinting ink formulation which is superior in many respects to those inks found in the prior art.

It is then preferred that the ink formulation of the present invention be impregnated into a fingerprinting pad constructed of any of a number of acceptable materials. Acceptable construction materials would include but not be limited to absorbent paper, chip board, and 7 to 11 micron porous plastic pads. These fingerprinting pad materials are then housed in a container and the user of the pad would merely open the container, press the digit to be printed on the pad transferring a quantity of ink to the finger or thumb, touching either onto a recording medium such as paper to record the fingerprint and having no remaining residue.

Of course, it is to be noted that variations in the amounts of the ingredients used for the present invention are to be expected, although these variations are expected to be less than approximately one percent (1%) variance. However, it is preferred that the ink formulation ingredients described herein be combined in approximately the same amounts as described to ensure proper functioning of the ink formulation. Furthermore, substitutions of various types of equivalent chemicals may be made to the present invention without deviating from the intended broad scope of the present description and the appended claims.

There has therefore been shown and described a novel fingerprint ink composition which accomplishes all of its intended objectives.

I claim:

1. A dye-based fingerprint ink formulation comprising:
a fatty-acid based dye dispersion including a fatty-acid based dye dispersed in a chemical composition including:
approximately equal first formulation parts of (a) 2 phenoxyethanol, (b) propylene glycol and (c) oleic acid;
approximately equal second formulation parts of (d) sorbitan monopalmitate and (e) myristic acid, said second formulation parts being approximately one-half the amount of said first formulation parts; and
said fatty-acid based dye comprising less than approximately one percent (1%), by weight, of said fatty-acid based dye dispersion.

2. The dye-based fingerprint ink formulation of claim 1 adapted for use in a fingerprinting pad, said fingerprinting pad being impregnated with said dye-based fingerprint ink formulation and further being housed in a container whereby a user of said fingerprinting pad would open the container, press the digit to be printed on said fingerprinting pad thereby transferring a quantity of said dye-based fingerprint ink formulation to the digit and touching the digit onto a fingerprint recording medium to record the fingerprint with substantially no ink residue remaining on the digit.
